(19) United States
(12) Patent Application Publication
(10) Pub. No.: US 2014/0245224 A1
(43) Pub. Date: Aug. 28, 2014

(54) METHOD OF DISPLAYING PROGRAMS AND ELECTRONIC DEVICE THEREFOR

(71) Applicant: Samsung Electronics Co., Ltd., Gyeonggi-do (KR)

(72) Inventor: Byoung-Tack ROH, Gyeonggi-do (KR)

(73) Assignee: Samsung Electronics Co., Ltd., Gyeonggi-do (KR)

(21) Appl. No.: 14/192,193

(22) Filed: Feb. 27, 2014

(30) Foreign Application Priority Data
Feb. 27, 2013 (KR) 10-2013-0021122

(51) Int. Cl. G06F 3/0482; G06F 3/0484; G06F 3/0488; G06F 3/0481

(52) U.S. Cl. CPC G06F 3/0482; G06F 3/04817; G06F 3/04842; G06F 3/0488
USPC 715/808

(57) ABSTRACT

A method of displaying programs and an electronic device thereof are provided. The method includes executing a first program, determining at least two related programs related to the first program, and displaying at least the two related programs on a reference region, a notification bar, or a pop-up window of a display unit on which the first program is executed, and a database is constructed such that the relation is verified in the database stored in the electronic device.

### PRIORITY

This application claims priority under 35 U.S.C. §119(a) to Korean Patent Application Serial No. 10-2013-0021122, which was filed in the Korean Intellectual Property Office on Feb. 27, 2013, the entire disclosure of which is incorporated herein by reference.

### BACKGROUND OF THE INVENTION

1. Field of the Invention

The present invention generally relates to an electronic device, and more particularly, to a method of displaying programs and an electronic device thereof.

2. Description of the Related Art

Electronic devices provide various functions such as a camera function, a data communication function, a video play function, an audio play function, a messenger function, a scheduling function, and an alarm function as well as a voice communication function. The electronic devices store various programs which may use the above-described functions. There is a trend of increasing the number of programs installed in the electronic device.

A conventional electronic device performs a method of searching an icon for executing a program, which is arranged on its display unit, selecting the searched icon, and executing the program. In the method of directly searching and executing the program, processes of searching and executing a desired program are complicated because of the large number of programs installed in the electronic device.

Also, in the electronic device, typically one program is executed and then related other programs are executed. Therefore, in a process of ending one program and searching and executing a desired next program on a list of many programs, it is obvious that the process is more complicated than in the past and requires more time. Of course, the electronic device provides various solutions for classifying programs by function as a group or in a folder, or providing some programs which include a link which may execute a specific program. However, there is a problem in that the electronic device has a restriction and limit to the solutions.

### SUMMARY OF THE INVENTION

An aspect of the present invention is to solve at least the above-mentioned problems and/or disadvantages and to provide at least the advantages described below.

Accordingly, an aspect of the present invention is to provide a method and apparatus for allowing a user to easily execute a desired next program by sorting various programs installed in an electronic device according to reference conditions and determining and providing programs related to an executed program.

Accordingly, another aspect of the present invention is to provide a method and apparatus for allowing a user to easily execute a desired second program by determining related programs related to an executed first program when the first program is executed in an electronic device, displaying connection icons which execute the related programs on a display unit where the first program is executed, and selecting one of the displayed icons.

Accordingly, another aspect of the present invention is to provide a method and apparatus for allowing a user to easily execute a desired second program by displaying related programs of a first program on a display unit of an electronic device by only a simple reference operation when the first program is ended in a state where a second program is not selected after the first program is executed.

Accordingly, another aspect of the present invention is to provide a method and apparatus for constructing a database which may be used in a process of determining related programs when a first program is executed.

In accordance with an aspect of the present invention, an operation method of an electronic device is provided. The operation method includes executing a first program, determining at least two related programs related to the first program, and displaying at least the two related programs on a reference region, a notification bar, or a pop-up window of a display unit on which the first program is executed, further comprising constructing a database such that the relation is verified in the database stored in the electronic device.

In accordance with another aspect of the present invention, an operation method of an electronic device is provided. The operation method includes executing a camera program, determining a map program, a gallery program, an SNS program, and a photo and video editing program as programs related to the camera program according to reference conditions, and displaying the related programs on a reference region, a notification bar, or a pop-up window of a display unit on which the camera program is displayed, wherein the related programs are determined by position relation between the camera program which stores position information and the map program which verifies a position of the electronic device in comparison with a database stored in the electronic device, format relation between a result format of the camera program and the gallery program which uses data of the result format, format or result relation between a result of the camera program and the SNS program which shares the result on online, and the format relation between the result format of the camera program and the editing program which uses the data of the result format.

In accordance with another aspect of the present invention, an operation method of an electronic device is provided. The operation method includes sensing a reference operation, while a linguistic program is executed or before a second program is executed after the linguistic program is executed and displaying related programs which are determined after the linguistic program is executed and are related to the linguistic program on a reference region, a notification bar, or a pop-up window of a display unit on which the linguistic program is displayed, when the reference operation is sensed, wherein the related programs include two or more of a dictionary program including the same language as the linguistic program using identification information of programs which are sorted in a database by a category, an online linguistic education program including the same language as the linguistic program, a local guide program for guiding countries or cities which use the same language as the linguistic program, and other linguistic programs.

In accordance with another aspect of the present invention, an electronic device is provided. The electronic device includes at least one processor, a memory, and at least one program, which is stored in the memory and is executed by at least the one processor, wherein the processor determines at least two related programs related to a first program and displays the at least two related programs on a reference region, a notification bar, or a pop-up window of a display unit on which the first program is executed and wherein the relation between the first program and the at least two related programs is verified in a database stored in the electronic device.

### BRIEF DESCRIPTION OF THE DRAWINGS

The above and other aspects, features and advantages of certain embodiments of the present invention will be more apparent from the following detailed description taken in conjunction with the accompanying drawings, in which:

FIG. 1 is a block diagram illustrating configuration of an electronic device according to an embodiment of the present invention;

FIG. 2 is a block diagram illustrating detailed configuration of a processor according to an embodiment of the present invention;

FIG. 3A is a flowchart illustrating a process of operating a related program when a program is executed in an electronic device according to an embodiment of the present invention;

FIG. 3B is a flowchart illustrating a process of operating a related program when a program is executed in an electronic device according to another embodiment of the present invention;

FIG. 4A is a flowchart illustrating a process of operating a related program when a program is executed in an electronic device according to another embodiment of the present invention;

FIG. 4B is a flowchart illustrating a process of operating a related program when a program is executed in an electronic device according to another embodiment of the present invention;

FIG. 5A is a screen view illustrating a process of executing a Graphic User Interface (GUI) operation which is displayed on a display unit of an electronic device when a program is executed in the electronic device according to an embodiment of the present invention;

FIG. 5B is a screen view illustrating a process of executing a GUI operation which is displayed on a display unit of an electronic device when a program is executed in the electronic device according to another embodiment of the present invention;

FIG. 6 is a screen view illustrating a process of executing a GUI operation which is displayed on a display unit of an electronic device when a program is executed in the electronic device according to another embodiment of the present invention;

FIG. 7A is a screen view illustrating a process of executing a GUI operation which is displayed on a display unit of an electronic device when a program is executed in the electronic device according to another embodiment of the present invention;

FIG. 7B is a screen view illustrating a process of executing a GUI operation which is displayed on a display unit of an electronic device when a program is executed in the electronic device according to another embodiment of the present invention;

FIG. 8A is a screen view illustrating configuration of a program of an electronic device according to an embodiment of the present invention;

FIG. 8B is a screen view illustrating configuration of a program of an electronic device according to an embodiment of the present invention; and

FIG. 8C is a screen view illustrating configuration of a program of an electronic device according to an embodiment of the present invention.

### DETAILED DESCRIPTION OF EMBODIMENTS OF THE PRESENT INVENTION

Embodiments of the present invention will be described herein below with reference to the accompanying drawings. In the following description, well-known functions or constructions are not described in detail since they would obscure the invention in unnecessary detail.

In describing an embodiment of the present invention, a description will be given for a touch screen which performs an input process through an input device and a display process through a display unit on one physical screen. Accordingly, although the display unit and the input device are separately included in the electronic device, the display unit may include the input device or the input device may be the display unit.

In addition, an embodiment of the present invention may be applied to at least one of various electronic devices without being limited to only the electronic device including the touch screen. For example, an embodiment of the present invention may be applied to an electronic device in which the display unit and the input device are physically separated.

Hereinafter, the electronic device includes at least one of a mobile communication terminal, a Personal Digital Assistant (PDA), a Personal Computer (PC), a laptop computer, a smart phone, a netbook, a Mobile Internet Device (MID), a Ultra Mobile PC (UMPC), a tablet PC, a mobile pad, a media player, a handheld computer, a navigation device, and a Moving Picture Experts Group (MPEG) layer 3 (MP3) player.

Hereinafter, in a detailed description for an embodiment of the present invention, when it is described that any component is “connected” or “accessed” to another component, it will be understood that the component may be directly connected or accessed to the another component, but there may be another component between the component and the another component. On the other hand, when it is described that any component is “directly connected” or “directly accessed” to another component, it will be understood that there is no another component between the component and the another component.

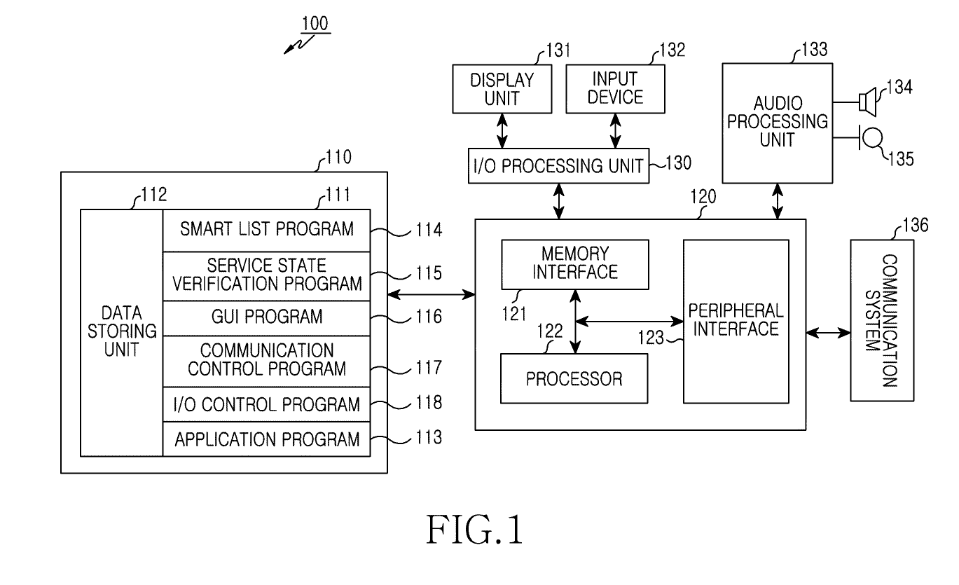

FIG. 1 is a block diagram illustrating configuration of an electronic device according to an embodiment of the present invention.

As shown in FIG. 1, the electronic device denoted by 100 may include a memory 110, a processor unit 120, an Input/Output (I/O) processing unit 130, a display unit 131, an input device 132, an audio processing unit 133, and a communication system 136.

A description will be give for each component as follows.

The memory 110 includes a program storing unit 111 for storing programs for controlling operations of the electronic device 100 and a data storing unit 112 for storing data generated while the programs are executed. The memory 110 may store data generated in programs by an operation of the processor 122.

For example, the data storing unit 112 stores information of a database which may be used in a process of determining related programs related to a first program executed through a smart list program 114 at the processor 122. The related programs may be determined by verifying a program ID from a header of the first program and determining the related programs in the database using the program ID.

For example, the database is made by configuring the relation between the first program and a second program to have the relation with each other when a source code of the first program or the second program includes a keyword or an instruction of the number of reference types or more, which is processed to perform the same function of the electronic device. The database is made by acquiring the number of times a second program is executed after the first program is executed and configuring the relation between the first program and the second program to have the relation with each other when the number of times the second program is executed is included in a reference number of times. The database is made by configuring the relation between the first program and the second program such that a second program which is another component of a first folder is related to the first program when the first program is one component of the first folder. The database is made by configuring the relation between the first program and the second program such that the second program and a third program which is another component of a second folder are related to the first program when the first program is one component of each of the first folder and the second folder.

The data storing unit 112 may store data such as setting information of the smart list program 114 necessary for configuring a GUI operation in a process of displaying the related programs on the display unit 131.

The program storing unit 111 includes the smart list program 114, a service state verification program 115, a GUI program 116, a communication control program 117, an I/O control program 118, and at least one application program 113. Herein, the programs included in the program storing unit 111 may be expressed in an instruction set as a set of instructions.

The smart list program 114 may sort and display programs installed in the memory 110 of the electronic device 100 according to reference conditions.

For one example, the processor 122 determines related programs related to a program executed through the smart list program 114 and display the determined related programs on the display unit 131. Also, when any one of the related programs is not selected and a program is ended, the processor 122 may perform a control operation to perform a reference operation and display the related programs on the display unit 131.

For another example, in order to determine related programs related to an executed program, the processor 122 classifies programs which are previously installed in the memory 110 of the electronic device 100 according to reference conditions by various methods such as an important function of each of the programs, the number of times each of the programs is used, and folder configuration through the smart list program 114 and configures database information. The processor 122 may correct the database information through a setting step of the smart list program 114.

The service state verification program 115 includes at least one software component for verifying states of services provided from programs or devices of the electronic device 100.

For one example, the service state verification program 115 ascertains a service state such as whether an error is generated in a process when the processor 122 sorts programs installed in the memory 110 of the electronic device 100 according to reference conditions and configures database information using the smart list program 114.

For another example, the service state verification program 115 ascertains a service state to perform a process according to setting information of the smart list program 114 in the process when the processor 122 determines related programs of an executed program using the smart list program 114.

For another example, the service state verification program 115 senses a reference operation when the reference operation is performed in the electronic device 100 in a process when the processor 122 recommends related programs using the smart list program 114 and ascertains a state about whether the processor 122 advances a procedure corresponding to the reference operation.

The GUI program 116 includes at least one instruction and at least one software component for providing a UI as graphics on the display unit 131.

For example, the processor 122 controls the GUI program 116 to configure GUI operations such as the number of related programs displayed on the display unit 131, a display method of the related programs, a display type of the related programs, transparency of icons, and a size of the icons according to setting information of the smart list program 114 in a process of displaying the related programs on the display unit 131.

The communication control program 117 may include at least are software component for controlling communication with at least one second electronic device using the communication system 136. For example, the communication control program 117 may search the second electronic device to communicate. If the second electronic device to communicate is searched, the communication control program 117 sets connection for communication with the second electronic device. Thereafter, the communication control program 117 controls the communication system 136 to perform a performance search procedure and a session establishment procedure with the connected second electronic device, and transmits and receives data such as alarm information with the second electronic device through the communication system 136.

The I/O control program 118 displays an operation of the electronic device 100 on the display unit 131 and receives an operation instruction of the electronic device through the input device 132 from the outside.

The application program 113 includes a software component for at least one application program installed in the memory 110 of the electronic device 100.

The memory 110 included in the electronic device 100 may be one or more memories. Also, the memory 100 may perform a function of only the program storing unit 111, perform a function of only the data storing unit 112, or perform the functions of both of them according to its purpose. A physical region in the memory 110 may be not classified accurately due to characteristics of the electronic device 100.

The processor unit 120 may include a memory interface 121, at least one processor 122, and a peripheral interface 123. Herein, the memory interface 121, at least the one processor 122, and the peripheral interface 123 which are included in the processor unit 120 may be integrated in at least one Integrated Circuit (IC) or be separately implemented.

The memory interface 121 controls processor 122 or the peripheral interface 123 to access the memory 110.

The peripheral interface 123 controls connection among an I/O peripheral of the electronic device 100, the processor 122, and the memory interface 121.

The processor 122 provides a variety of services such as multimedia and communication using at least one software program. The processor 122 displays a GUI operation of the electronic device 100 on the display unit 131 through the I/O processing unit 130 to verify the GUI operation of the electronic device 100. The processor 122 controls the input device 132 to provide a service in which it receives an instruction from the outside of the electronic device 100 through the input device 132. Herein, the processor 122 performs a control operation to execute at least one program stored in the memory 110 and provide a service according to the corresponding program.

The communication system 136 performs a communication function. For example, the communication system 136 may perform communication with the second electronic device using at least one of mobile communication such as communication through a base station, local-area wireless communication such as an Infrared Data Association (IrDA) communication, Bluetooth communication, and wireless Local Area Network (LAN) communication, and wired communication.

The input device 132 may be included in the display unit 131 by a touch screen type. Herein, the touch screen type may be used in a touch screen which operates by a capacitive type, a touch screen which operates by a resistive type, etc.

The display unit 131 receives state information of the electronic device 100, characters input by the user, moving pictures, still pictures, etc. from the processor unit 120 and displays the received data through the I/O processing unit 130. For example, the processor 122 controls the display unit 131 to display related programs related to a program executed in the electronic device 100 according to setting information of the smart list program 114.

When the display unit 131 is configured as a touch screen like the input device 132, all functions of the display unit 131 and functions of the input unit 132 are performed on one screen.

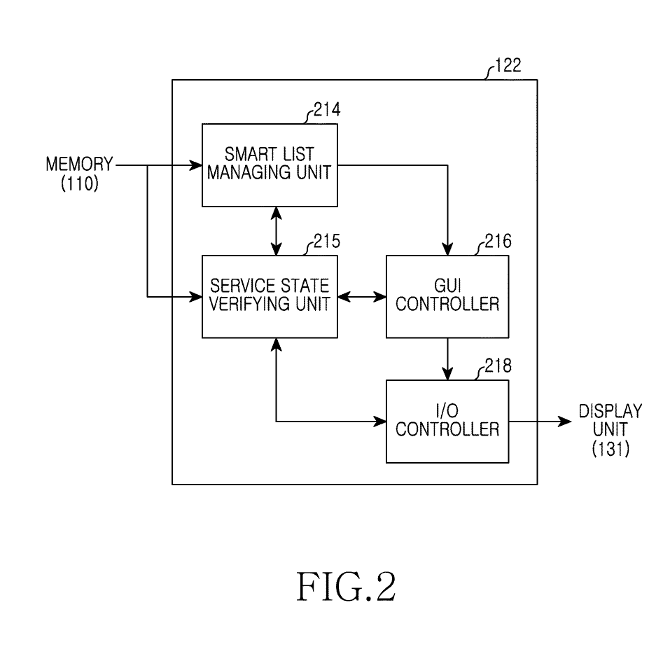

FIG. 2 is a block diagram illustrating detailed configuration of a processor according to one embodiment of the present invention.

The processor 122 performs an operation of determining at least two related programs related to a first program and displaying the at least two related programs on a reference region, a notification bar, or a pop-up window of a display unit on which the first program is executed and wherein the relation between the first program and the at least two related programs is verified in a database stored in the electronic device.

The processor 122 performs an operation of using information about a category, the number of times of download, and an evaluation score of the first program or a second program as a component of the database on an online store which downloads the first program or the second program. The processor 122 performs an operation of setting information of a category when there is no information of the category or resetting information of a category when there is the information of the category while downloading the first program or the second program on the online store and using the information of the category as a component of the database. The processor 122 performs an operation of using information of a category provided from a manufacturer of the first program or the second program through a network server or the Internet as a component of the database. The processor 122 performs an operation of using information verified in a meta tag of an online page for the first program or the second program provided from the manufacturer as a component of the database.

The processor 122 performs an operation of verifying a program ID from a header of the first program and determining the related programs in the database using the program ID.

The processor 122 performs an operation of configuring the relation between the first program and the second program to have the relation with each other when a source code of the first program or the second program includes a keyword or an instruction of the number of reference types or more, which is processed to perform the same function of the electronic device.

The processor 122 performs an operation of displaying the at least two related programs when a reference operation is sensed before the second program is executed after the first program is executed.

The processor 122 performs an operation of acquiring the number of times a second program is executed after the first program is executed and configuring the relation between the first program and the second program to have the relation with each other when the number of times the second program is executed is included in the reference number of times.

The processor 122 performs an operation of configuring the relation between a second program which is another component of a first folder and the first program when the first program is one component of the first folder.

The processor 122 performs an operation of configuring the relation between the second program and a third program which is another component of a second folder and the first program when the first program is one component of each of the first folder and the second folder.

As shown in FIGS. 1 and 2, the processor 122 include a smart list managing unit 214, a service state verifying unit 215, a GUI controller 216, and an I/O controller 218.

The smart list managing unit 214 performs a control operation to execute the smart list program 114 and determines programs included in the same or similar category among programs installed in the electronic device 100.

For example, the smart list managing unit 214 performs a control operation to verify information of a program executed in the electronic device 100, determines programs having at least two or more relations which are stated above included in a category of the same or similar programs as the executed program or a category of programs which may be used by interworking with output of the executed program using information of various programs installed in the electronic device 100, and allows the GUI controller 216 and the I/O controller 218 to display the determined programs on the display unit 131 according to a set method.

Also, when one of the programs displayed on the display unit 131 is executed, the smart list managing unit 214 performs a control operation to repeatedly perform a process of verifying information of the executed program and determining and displaying related programs.

In addition, in the process of determining and displaying programs included in the same or similar category and executing a selected program, the smart list managing unit 214 performs a control operation to allow the service state verifying unit 215 to execute the service state verification program 115.

The service state verifying unit 215 executes the service state verification program 115 and verifies and control a state of a service which provides an organic relation between programs and devices installed in the electronic device 100.

For example, the service state verifying unit 215 performs a control operation to verify information of an executed program and determine programs related with the executed program among various programs installed in the memory 110 of the electronic device 100 by interworking with the smart list managing unit 214. Also, when a program which is not stored as data is executed, the service state verifying unit 215 performs a control operation to generate category information for determining relation and stores the generated category information in the memory 110.

The relation may be determined based on the database which comprises configuring the relation between the first program and a second program by using at least one of using information about a category, the number of times of download, and an evaluation score of the first program or the second program as a component of the database on an online store which downloads the first program or the second program,

The relation may be determined based on the database which comprises setting information of a category when there is no information of the category or resetting information of a category when there is the information of the category while downloading the first program or the second program on the online store and using the information of the category as a component of the database,

The relation may be determined based on the database which comprises using information of a category provided from a manufacturer of the first program or the second program through a network server or the Internet as a component of the database,

The relation may be determined based on the database which comprises using information verified in a meta tag of an online page for the first program or the second program provided from the manufacturer as a component of the database.

The related programs may be determined by verifying a program ID from a header of the first program; and determining the related programs in the database using the program ID.

For example, the database comprises configuring the relation between the first program and a second program to have the relation with each other when a source code of the first program or the second program includes a keyword or an instruction of the number of reference types or more, which is processed to perform the same function of the electronic device. The database comprises acquiring the number of times a second program is executed after the first program is executed and configuring the relation between the first program and the second program to have the relation with each other when the number of times the second program is executed is included in a reference number of times. The database comprises configuring the relation between the first program and the second program such that a second program which is another component of a first folder is related to the first program when the first program is one component of the first folder. The database comprises configuring the relation between the first program and the second program such that the second program and a third program which is another component of a second folder is related to the first program when the first program is one component of each of the first folder and the second folder.

For another example, the service state verifying unit 215 performs a control operation such that programs determined from the smart list managing unit 214 are configured and operated according to a set GUI by interworking with the GUI controller 216.

For another example, the service state verifying unit 215 performs a control operation to verify a state where GUIs configured from the GUI controller 216 are displayed on the display unit 131 by interworking with the I/O controller 218.

The GUI controller 216 performs a control operation to configure visual information needed to be displayed on the display unit 131 of the electronic device 100 by interworking with the GUI program 116.

For example, the GUI controller 216 performs a control operation to configure programs determined from the smart list managing unit 214 to be displayed and operated according to GUI information which is preset in the memory 110 on the display unit 131 of the electronic device 100 and allows the I/O controller 218 to display the configured programs.

The I/O controller 218 displays an operation of the electronic device 100 which is configured as visual information in the GUI controller 216 on the display unit 131 by interworking with the I/O control program 118.

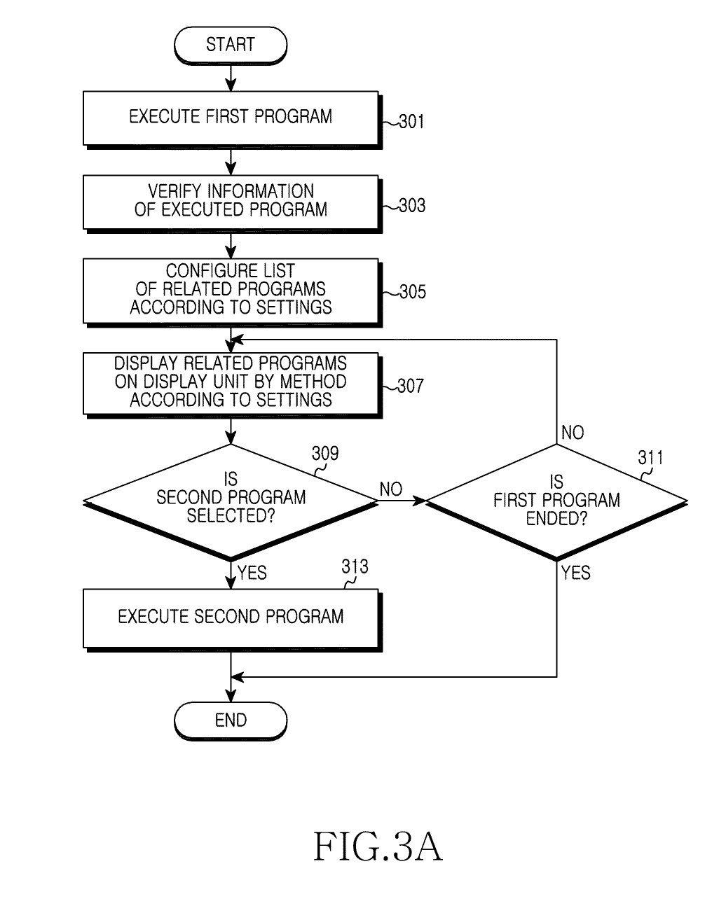

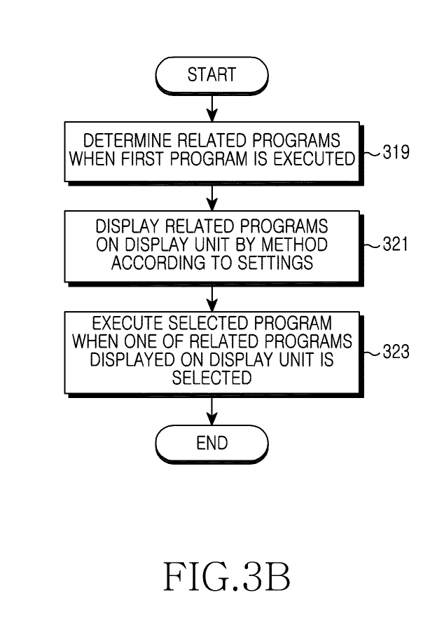

FIG. 3A is a flowchart illustrating a process of operating a related program when a program is executed in an electronic device according to an embodiment of the present invention.

Referring to FIGS. 1 and 3A, a general method of executing a second program related to a first program in a state where the first program is executed includes a series of steps of executing the second program by a simple operation without performing the operations of several steps of ending the first program, searching or verifying the second program on a program list, and executing the second program.

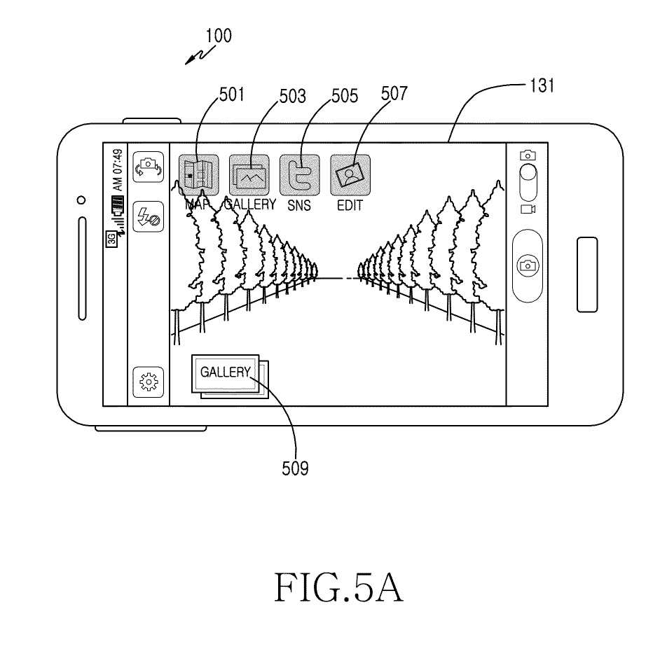

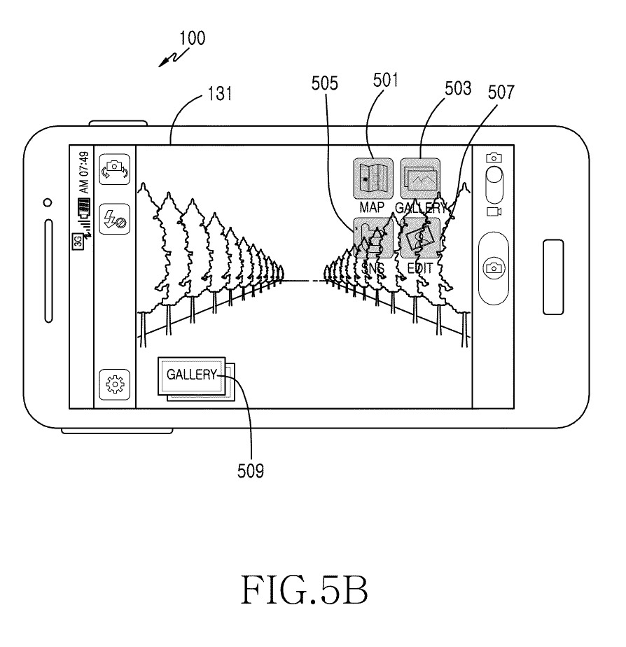

Hereinafter, as shown in FIGS. 3A and 5A, when the first program is set, for example to a program such as an image capturing program #1 and is then executed, a description will be given for a method of automatically determining related programs which may be executed next using a database and setting information of the smart list program 114, displaying the related programs on the display unit 131 according to the set information, selecting a map program 501 as a second program among the map program 501, a gallery program 503, a Social Networking Service (SNS) program 505, and a photo editing program 507 which are determined as the related programs, and executing the selected map program 501.

Hereinafter, a description will be given in detail for the respective steps of FIG. 3A.

If an execution command of the first program is input from the input device 132, the processor 122 performs a control operation to execute the first program and display a GUI operation on the display unit 131 in step 301.

For example, when an execution command of the image capturing program #1 is input through the input device 132, the processor 122 performs a control operation to execute the image capturing program #1 and display a GUI operation for the image capturing program #1 on the displays unit 131.

The first program executed in step 301 according to an embodiment of the present invention may be any program which may be stored in the memory 110 of the electronic device 100 and display a GUI operation for itself on the display unit 131.

In step 303, the processor 122 verifies an identification code such as an IDentification (ID) of the first program executed in step 301.

For example, when the image capturing program #1 is executed, the processor 122 acquires a program ID to identify the program, from a program header and verifies that the executed image capturing program #1 is sorted into an image capturing program #1 of a camera category of a database of the smart list program 114.

In step 305, the processor 122 configures a list of programs related to the image capturing program #1 from the database.

At this time, the processor 122 determines various information, such as the number of programs to be displayed on the display unit 131, priorities among the same or similar range (same category) programs, and priorities when being displayed on the display unit 131, according to set information of the smart list program 114.

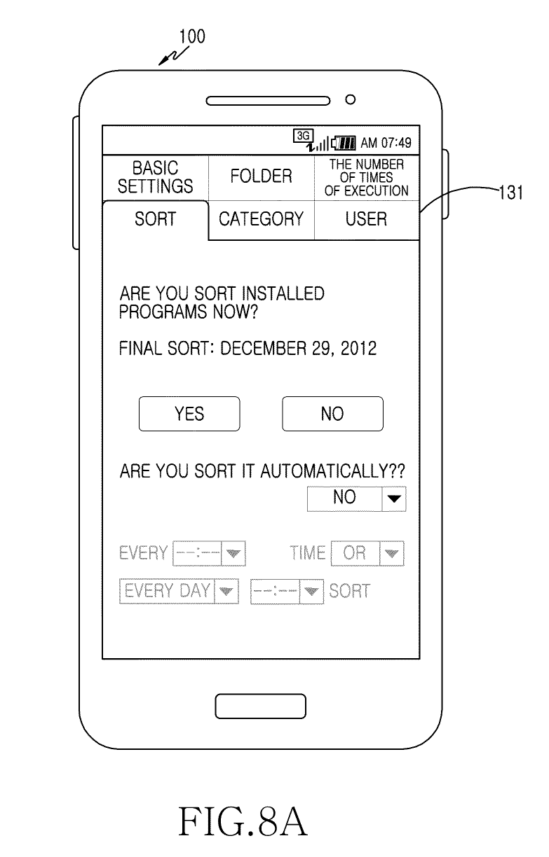

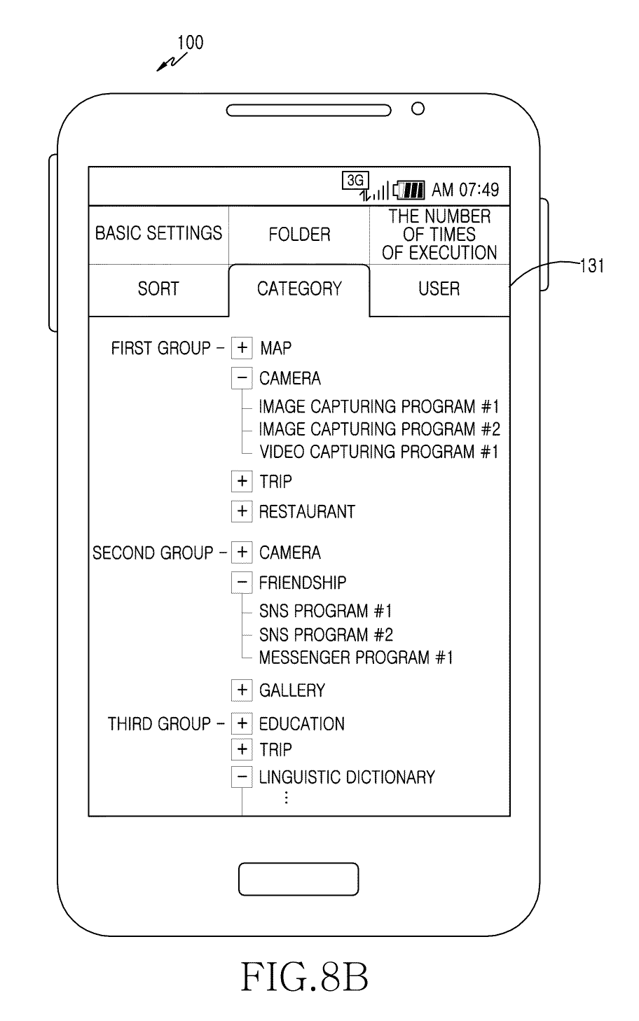

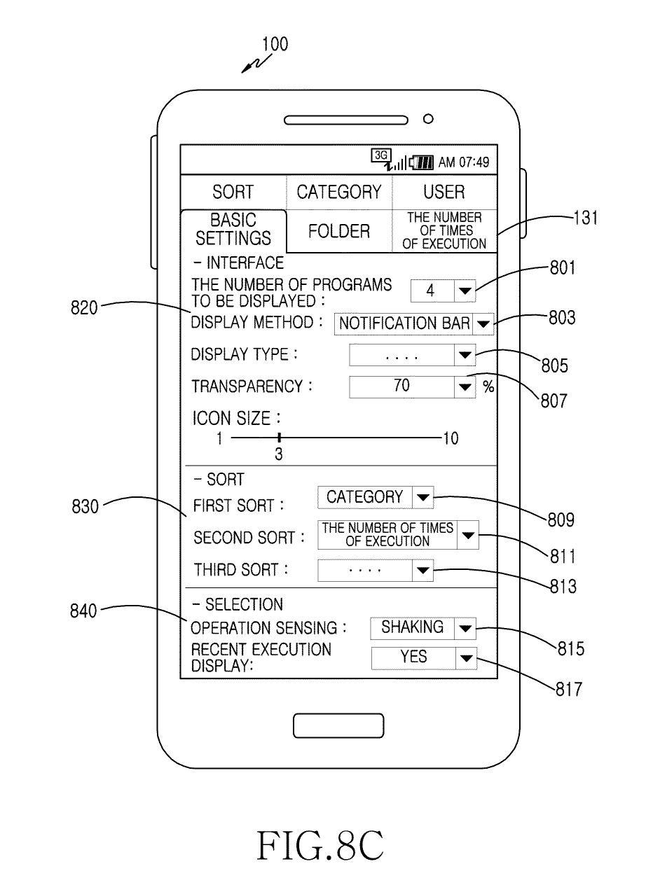

For example, the processor 122 sorts and stores programs installed in the memory 110 of the electronic device 100 in a database in a setting step (see FIGS. 8A to 8C) of the smart list program 114. The database may include not only the program ID for the image capturing program #1 but also an ID of each of programs installed in the memory 110 of the electronic device 100, a list of programs corresponding to a previously classified category, the total number of times the image capturing program #1 and programs are executed, date and time information in which programs are recently executed, information of a program executed just after the first program is executed, etc.

When setting information of the smart list program 114 is set to information shown in FIG. 8C (e.g., the number of programs to be displayed (801) on the display unit 131: 4, a display method (803): a left upper end of the display unit 131, a display type (805): to be long left and right, transparency (807): 70%, an icon size: 3, a first sort (809): a category, and a second sort (811): an execution order), the processor 122 verifies a program ID of the database, filters programs sorted in the database according to a first sort method, and filters the results according to a second sort method. The processor 122 determines the programs obtained by the second filtering as related programs according to the number of programs to be displayed on the display unit 131.

Referring to FIGS. 5A and 5B, the processor 122 verifies that the map program 501, the gallery program 503, the SNS program 505, and the photo editing program 507 are determined as programs related to the image capturing program #1 in step 305.

In addition, the related programs of the image capturing program determined in step 305 by the processor 122 may be changed according to setting information of the smart list program 114 and configuration of database information.

In step 307, the processor 122 controls the display unit 131 to display the related programs determined in step 305 according to the setting information of the smart list program 114.

For example, when the setting information of the smart list program 114 is set to information shown in FIG. 8C, the processor 122 displays 4 programs at transparency of 70% and an icon size 3 to be long left and right from a left upper end of the display unit 131 using the GUI program 116 (see FIG. 5A).

For another example, when the setting information of the smart list program 114 is stored such as the number of programs to be displayed on the display unit 131: 4, a display method: a right upper end of the display unit 131, a display type: a square, transparency: 70%, an icon size: 3, a first sort: a category, and a second sort: an execution order, the processor 122 may display 4 programs, as shown in FIG. 5B.

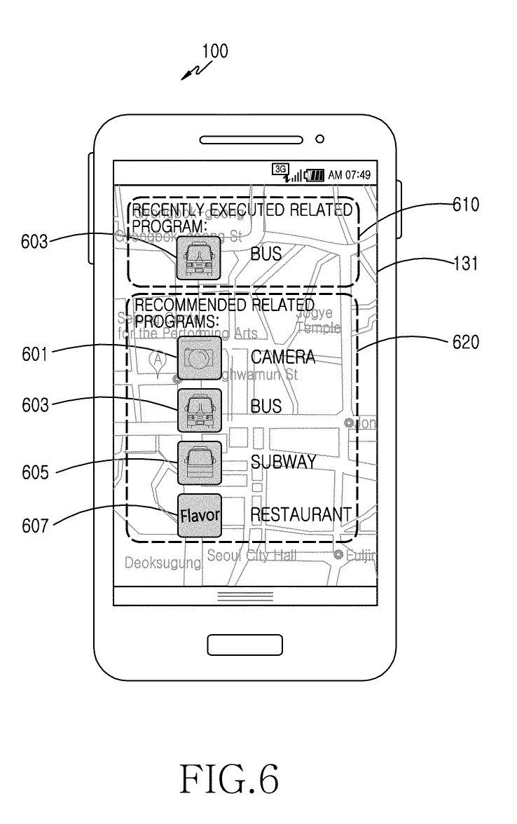

For another example, if a display method of setting information of the smart list program 114 is set to “display on a notification bar”, the processor 122 performs a control operation to display the setting information of the smart list program 114 on the notification bar instead of directly displaying, as shown in FIG. 5A or 5B, the setting information on the display unit 131 where the image capturing program #1 is executed (see FIG. 6).

Displaying related programs on the display unit 131, when the display unit 131 is a touch screen, in which the display unit 131 is integrated with the input device 132, which may display and input information on one screen, the processor 122 may display the related programs as icons, in which each of them is connected with the corresponding one program, to execute a program selected by touching (selecting) one of the related programs.

In step 309, the processor 122 verifies whether a second program, which is one of the related programs displayed on the display unit 131, is selected through the input device 132 in step 309.

For example, the processor 122 waits for a selection of one of the related programs displayed in step 307 on the display unit 131 through the input device 132 during an operation of the image capturing program #1 in step 309. When one of the related programs is selected, the processor 122 proceeds to step 313. On the contrary, if there is no selection of the related programs displayed on the display unit 131, the processor 122 proceeds to step 311.

In step 313, the processor 122 executes the program (the second program) selected among the related programs displayed on the display unit 131 through the input device 132, and then ends the algorithm of FIG. 3A.

In addition, the processor 122 may repeat the process of FIG. 3A after performing step 313 to determine related programs of the program selected and executed in steps 309 and 313 and display the related programs on the display unit 131 according to the setting information of the smart list program 114.

Referring to FIGS. 3A and 6, FIG. 6 illustrates an example of selecting the map program 501 among the map program 501, the gallery program 503, the SNS program 505, and the photo editing program 507 of FIG. 5A which are displayed on the display unit 131 in step 307.

The processor 122 determines programs related with the selected map program 501 (the second program), displays the determined programs on a notification bar, and verifies that an image capturing program #1 601, a bus route map program 603, a subway route map program 605, and a restaurant program 607 are determined as the programs related to the map program 501.

Also, a box 610 designated by a dotted line indicates that the bus route map program 603 is selected among the related programs while the map program 501 is executed.

To change the display method from the left upper end of the display unit 131 to the notification bar which is the setting information in step 307 is shown in several embodiments. The setting information may be selected on a setting menu of the smart list program 114.

If the second program is not selected in step 309, the processor 122 determines if the image capturing program #1 has ended through the input device 132 in step 311. If the image capturing program #1 has ended, the process ends.

For example, in the operation of the image capturing program #1, the process of step 311 is an extension of the process of step 309. When one of the related program is not selected in step 309, the processor 122 may hold a display state of the related programs in step 307 and simultaneously verify that the image capturing program #1 is ended in step 311.

If a command for ending the image capturing program #1 is input through the input device 132 in step 311, the processor 122 ends the image capturing program #1, and then end the algorithm of FIG. 3A.

When there is no end command of the image capturing program #1 through the input device 132 in step 311 and one of the related programs is not selected in step 309, the processor 122 performs the processing operation from step 307. That is, the processor 122 displays the related programs on the display unit 131 and waits to select one of the related programs while executing the image capturing program #1.

In addition, the smart list program 114 may always operate by the processor 122 or operate when the first program such as the image capturing program #1 is executed.

Referring to FIG. 3B, a description will be given for a detailed process of determining related programs using the smart list program 114, with further reference to FIGS. 8A to 8C.

FIG. 3B is a flowchart illustrating a process of operating a related program when a program is executed in an electronic device according to another embodiment of the present invention.

Referring to FIGS. 1, 3A, and 3B, the processor 122 determines related programs when a first program is executed using the smart list program 114 in step 319, displays the related programs on the display unit 131 by a method according to settings in step 321, and executes a selected program when one of the related programs displayed on the display unit 131 is selected while the first program is executed in step 323.

Step 319 of determining the related programs when the first program is executed may include 301 of executing the first program and displaying the GUI operation for the first program on the display unit 131, step 303 of verifying the information about the executed first program using the setting information and database of the smart list program 114, and step 305 of determining the programs related with the executed first program.

Step 321 of displaying the related programs on the display unit 131 by the method according to the settings may include step 307 of determining the display method, determining the display type, determining the transparency, determining the icon size, and displaying the related programs on the display unit 131, when displaying the determined related programs on the display unit 131. At this time, the processor 122 may use the setting information of the smart list program 114 and the GUI program 116.

Step 323 of executing the selected program when one of the related programs displayed on the display unit 131 is selected may include step 309 of selecting one of the related programs and step 313 of executing the selected program.

In addition, the processor 122 may further include step 309 of not selecting one of the related programs and step 311 of ending the first program without executing the related program.

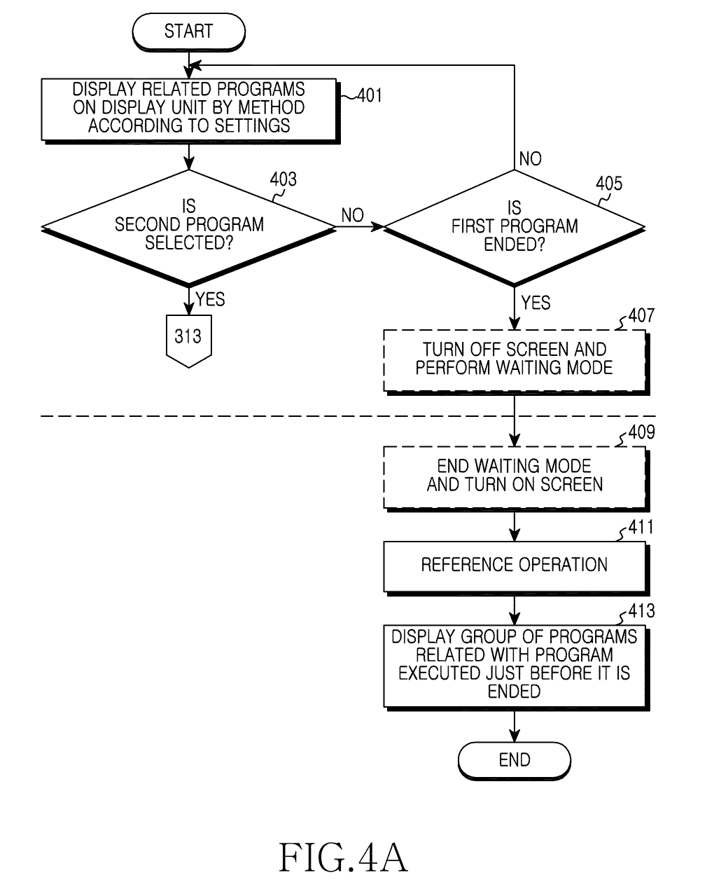

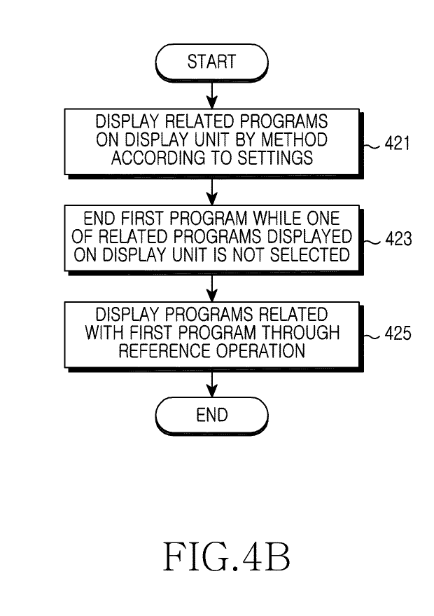

FIG. 4A is a flowchart illustrating a process of operating a related program when a program is executed in an electronic device according to another embodiment of the present invention.

Referring to FIGS. 1, 3A, and 4A, in step 401, the processor 122 displays related programs related to a first program in a state where the first program is executed according to setting information of the smart list program 114 on the display unit 131 where the first program is executed. However, assuming that the first program ends without selecting any one of related programs as a second program and the electronic device 100 is converted into a waiting state, before the waiting state of the electronic device 100 is released or another program is executed, the processor 122 performs a series of steps of displaying programs related with the first program on the display unit 131 by a reference operation.

Hereinafter, as shown in FIG. 4A, using an example of determining and executing the first program as an English-Korean dictionary program, the processor 122 determines related programs which may be executed next and displays the determined related programs on the display unit 131 in step 401. However, when the processor senses a reference operation in a state where the English-Korean dictionary program ends and another program is not executed when the English-Korean dictionary program is ended without selecting the second program, a description will be given for a process of displaying 4 programs such as an English-English dictionary program 701, a local guide program 703, a radio program 705, and a question exercise program 707 which are determined as related programs of the English-Korean dictionary.

Although it is not shown in FIG. 4A, prior to describing a process of step 401, as shown FIG. 3A, the processor 122 determines the first program as the English-Korean dictionary program in steps 301, 303, and 305 and proceeds to step 401. A description will be briefly given for processes performed before the process of step 401 using steps 301, 303, and 305.

For example, when a command for executing the English-Korean dictionary program is input to the electronic device 100, the processor 122 performs step 301 of executing the English-Korean dictionary program and displaying a GUI operation for the English-Korean dictionary program on the display unit 131, step 303 of verifying information about the English-Korean dictionary program stored in a database of related programs stored in the memory 110 through the smart list program 114, step 305 of determining the English-English dictionary program 701, the local guide program 703, the radio program 705, and the question exercise program 707 as related programs according to setting information of the smart list program 114, and step 307 of displaying the related programs on the display unit 131 according to the setting information of the smart list program 114.

Hereinafter, a description will be given for the respective steps of FIG. 4A.

The processor 122 controls the display unit 131 to display the related programs determined according to the setting information of the smart list program 114 in step 401.

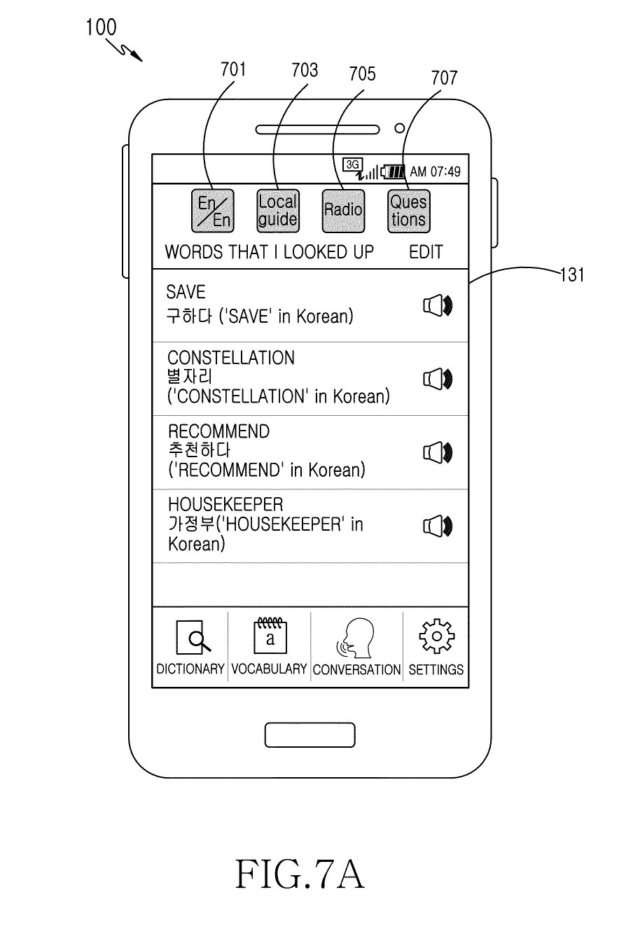

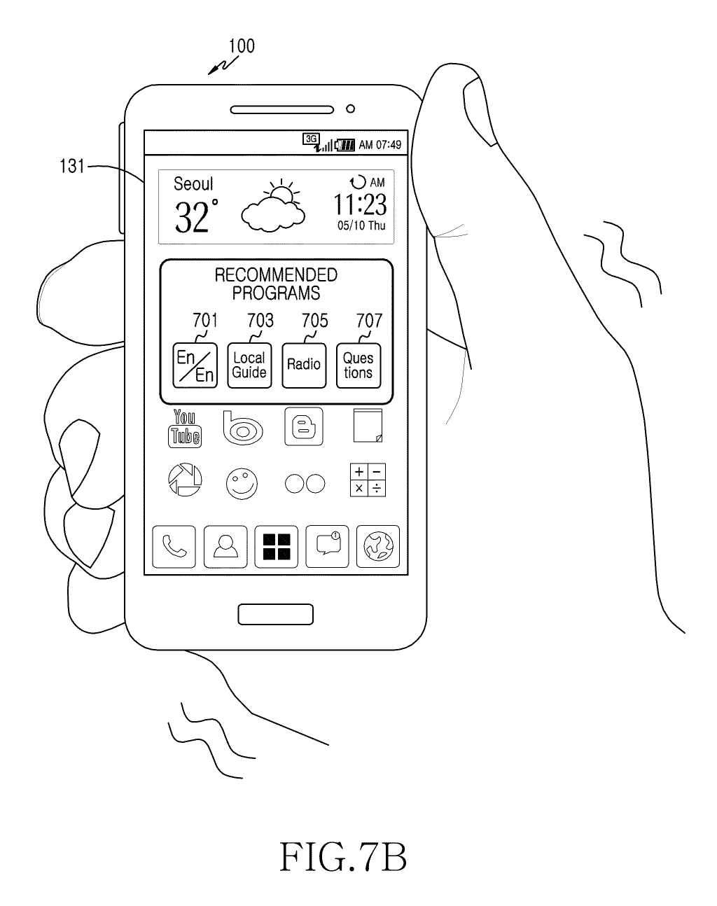

For example, as shown in FIG. 8C, the setting information of the smart list program 114 is stored as information such as the number of programs to be displayed on the display unit 131: 4, a display method: a central upper end of the display unit 131, a display type: to be long left and right, transparency: 70%, and an icon size: 3, the processor 122 displays related programs shown in FIG. 7A on the display unit 131.

In step 403 the processor 122 determines whether one of the related programs displayed on the display unit 131 is selected through the input device 132 in step 403.

For example, the processor 122 waits to select one of the related programs displayed on the display unit 131 in step 401 through the input device 132 while the English-Korean dictionary program operates in step 403. When one of the related programs is selected within a reference time, the processor 122 proceeds to step 313 of FIG. 3A to execute the selected second program.

In step 313, the processor 122 repeats the processes of FIG. 3A. to determine related programs of the program selected and executed in steps 309 and 313 and displays the related programs on the display unit 131 according to the setting information of the smart list program 114.

On the other hand, when one of the related programs displayed on the display unit 131 is not selected, the processor 122 proceeds to step 405. The processor 122 determines whether the English-Korean dictionary program (first program) ends through the input device 132 in step 405.

For example, step 405 is an extension of the process of step 403 in the operation of the English-Korean dictionary program. When one of the related programs is not selected in step 403 and the English-Korean dictionary program has not ended in step 405, the processor 122 holds the display state of the related programs in step 401.

If an end command of the English-Korean dictionary program is input through the input device 132 in step 405, the processor 122 proceeds to step 407.

The electronic device 100 is converted into a waiting state in step 407. The English-Korean dictionary program is ended and a screen of the display unit 131 is also in an off state. The electronic device 100 releases the waiting state in step 409. The electronic device 100 releases the waiting state by a general method of turning on the screen of the display unit 131.

Steps 407 and 409 indicate that there is a time difference from when the processor 122 ends the English-Korean dictionary program in step 405 and proceeds to step 411. Therefore, before executing another program after ending the English-Korean dictionary program in step 405, the processor 122 may omit the steps 407 and 409 and proceed directly to step 411.

In FIG. 4A, the dotted line between the steps 407 and 409 means that there is a time difference until the processor 122 ends the English-Korean dictionary program in step 405 and proceeds to step 411.

The processor 122 may sense that the electronic device 100 performs a reference operation in step 411 according to the setting information of the smart list program 114.

For example, when an operation for shaking the electronic device 100 is set as the reference operation in the smart list program 114, upon sensing the operation for shaking the electronic device 100 in step 411, the processor 122 proceeds to step 413.

For another example, when an operation for pushing a first button of the electronic device 100 is set as the reference operation in the smart list program 114, upon sensing the operation for pushing the first button, the processor 122 proceeds to step 413.

Upon sensing the reference operation, the processor 122 controls the display unit 131 to display the related programs on a certain region of the display unit 131 in step 413.

For example, upon sensing the operation (reference operation) for shaking the electronic device 100 in a state where the English-Korean dictionary program has ended in step 405 and another program is not executed, the processor 122 displays related programs of the English-Korean dictionary program which has ended in step 405 on the display unit 131 according to the setting information of the smart list program 114. Referring to FIG. 7B, the processor 122 verifies that the related programs displayed on the central upper end of the display unit 131 in step 401 is displayed in a pop-up window by performing the operation (reference operation) for shaking the electronic device 100 in the state where the English-Korean dictionary program has ended in step 405 of FIG. 4A.

Although the English-Korean dictionary program has ended in step 405, to display the related programs of the English-Korean dictionary program on the display unit 131 by the reference operation may be described such that the processor 122 performs a control operation to store a list of the related programs of the English-Korean dictionary program and displays the list of the related programs of the English-Korean dictionary program, which is stored in the memory by the reference operation, on the display unit 131 again.

If the process of step 413 is performed, the processor 122 ends the process of FIG. 4A.

FIG. 4B is a flowchart illustrating a process of operating a related program when a program is executed in an electronic device according to another embodiment of the present invention.

Referring to FIGS. 1, 4A, and 4B, the processor 122 includes step 421 of displaying related programs on the display unit 121 by a method according to settings using the smart list program 114, step 423 of ending the first program while one of the related programs displayed on the display unit 131 is not selected, and step 425 of displaying programs related to the first program on the display unit 131 through a reference operation.

Step 421 of displaying the related programs on the display unit 121 by the method according to the settings may include step 401 of determining a display method, the process (step 401) of determining a display type, determining transparency, displaying related programs on the display unit 131, and t determining an icon size. At this time, the processor 122 may use setting information of the smart list program 114 and the GUI program 116.

Step 423 of ending the first program while one of the related programs displayed on the display unit 131 is not selected may include step 403 of holding the operation of the first program without selecting one of the related programs and step 405 of ending the first program when the end command of the first program is input through the input device 132.

Step 425 of displaying the programs related to the first program on the display unit 131 through the reference operation may include step 411 of performing the reference operation in the state where the first program has ended and another program is not executed and step 413 of displaying the programs related to the first program on the display unit 131 when sensing the reference operation.

FIG. 5A is a screen view illustrating a process of executing a GUI operation which is displayed on a display unit of an electronic device when a program is executed in the electronic device according to an embodiment of the present invention.

Referring to FIGS. 1, 3A, and 5A, FIG. 5A illustrates an example of executing the first program, determining the programs related to the first program, and displaying the determined programs on the display unit 131 in FIG. 3A.

For example, the processor 122 controls the display unit 131 to display a GUI operation when the first program is executed. If an image capturing program #1 is executed, the display unit 131 of FIG. 5A displays a screen for image capturing. A first gallery program 509 is configured together when the image capturing program #1 is executed and is displayed on the display unit 131.

The processor 122 performs a control operation to determine related programs related to the image capturing program #1 through information of a database of the smart list program 114 and displays the determined related programs as icons on the display unit 131. FIG. 5A illustrates that a map program 501, a second gallery program 503, an SNS program 505, and a photo editing program 507 are determined as the related programs.

Having a touch screen in which the display 131 for displaying a GUI operation and the input device 132 for receiving a command from the outside are implemented on one screen, the electronic device 100 displays the related programs as icons, each of them linked with each of the programs, to execute a program selected by an operation for touching (selecting) one of the related programs.

The first gallery program 509 is basically stored in the memory 110 of the electronic device 100. In general, if the image capturing program #1 is executed, the processor 122 displays an icon which may execute the first gallery program 509 on the display unit 131 of the electronic device 100 where the image capturing program #1 is executed to easily verify photos or moving pictures captured by the image capturing program #1.

If a second gallery program 503, which differs from the first gallery program, is installed in the memory 110 of the electronic device 100, the processor 122 may perform a control operation to determine the second gallery program 503 as a related program of the image capturing program #1 using information of a database of the smart list program 114 and display the determined second gallery program 503 on the display unit 131.

In addition, the second gallery program 503 may be displayed or not be displayed as the related program on the display unit 131 according to configuration of setting information of the smart list program 114 and configuration of information of the database of the smart list program 114. Accordingly, if the image capturing program #1 is executed, it may be changed so that the map program 501, the SNS program 505, and the photo editing program 507 may be displayed.

FIG. 5B is a screen view illustrating a process of executing a GUI operation which is displayed on a display unit of an electronic device when a program is executed in the electronic device according to another embodiment of the present invention.

Referring to FIGS. 1, 5A, and 5B, in order to configure a GUI operation of related programs displayed on the display unit 131 in step 307 of FIG. 3A, the processor 122 configures the GUI operation according to setting information of the smart list program 114.

For example, referring to FIG. 8C, if the setting information of the smart list program 114 is set to information such as the number of programs to be displayed: 4, a display method: a right upper end of the display unit 131, a display type: a square, transparency: 70%, and an icon size: 3, the processor 122 configures and displays, as shown in FIG. 5B, the map program 501, the second gallery program 503, the SNS program 505, and the photo editing program 507 on the display unit 131.

For another example, referring to FIG. 8C, if the setting information of the smart list program 114 is set to information such as the number of programs to be displayed: 4, a display method: a left upper end of the display unit 131, a display type: to be long left and right, transparency: 70%, and an icon size: 3, the processor 122 configures and displays, as shown in FIG. 5A, the map program 501, the second gallery program 503, the SNS program 505, and the photo editing program 507 on the display unit 131.

Therefore, the processor 122 may display configuration of a GUI operation displayed on the display unit 131 differently by changing the setting information of the smart list program 114.

FIG. 6 is a screen view illustrating a process of executing a GUI operation which is displayed on a display unit of an electronic device when a program is executed in the electronic device according to another embodiment of the present invention.

Referring to FIGS. 1, 5A, 5B, and 6, in the configuration of a GUI operation of the display unit 131, it may be assumed that the map program 501 of FIG. 5A or 5B is selected in step 309 of FIG. 3A as the second program, and the map program 501 is executed in step 313 of FIG. 3A.

When the map program 501 is executed, the processor 122 performs a control operation to determine related programs having relation with the map program 501, configures a GUI operation of the related programs according to setting information of the smart list program 114, and displays the configured GUI operation on the display unit 131.

When the image capturing program #1 (first program) executed in FIG. 5A or 5B, and the map program 501, the second gallery program 503, the SNS program 505, and the photo editing program 507 which are determined as the related programs of the image capturing program #1 and displayed on the display unit 131, are compared with a map program (first program) executed in FIG. 6, and an image capturing program #1 601, a bus route map program 603, a subway route map program 605, and a restaurant search program 607 which are determined as related programs of the map program and displayed on the display unit 131, it is verified that the related programs displayed on the display unit 131 differ according to the executed first program.

In addition, the related programs of FIG. 6 are displayed on a notification bar without being located on a certain region of the map program of the display unit 131. Referring to FIG. 8C, the processor 122 displays the related programs on the notification bar by selecting the display method 803 as the “notification bar” in a setting step of the smart list program 114.

For example, the processor 122 displays one related program selected when recently executing a map program by selecting a recent execution display 817 as “yes”.

For another example, the processor 122 may use a method of displaying the most selected program (second program) among related programs of a map program (first program), in addition to the recent execution display 817.

FIG. 7A is a screen view illustrating a process of executing a GUI operation which is displayed on a display unit of an electronic device when a program is executed in the electronic device according to another embodiment of the present invention.

Referring to FIGS. 1 and 7A, when an English-Korean dictionary program is executed and setting information of the smart list program 114 is set to information such as the number of programs to be displayed on the display unit 131: 4, a display method: a central upper end of the display unit 131, a display type: to be long left and right, transparency: 70%, and an icon size: 3, a user of the electronic device 100 may verify configuration of the display unit 131.

Also, the user of the electronic device 100 may verify that an English-English dictionary program 701, a local guide program 703, a radio program 705, and a question exercise program 707 are displayed as related programs of the English-Korean dictionary program.

FIG. 7B is a screen view illustrating a process of executing a GUI operation which is displayed on a display unit of an electronic device when a program is executed in the electronic device according to another embodiment of the present invention.

FIG. 7B illustrates the electronic device 100 which displays related programs of a finally executed program on the display unit 131 when sensing a reference operation.

For example, as shown in FIG. 7A, it is assumed that any one program is not selected as a next executed program and the English-Korean dictionary program has ended in the state where the English-Korean dictionary program is executed as the first program and the English-English dictionary program 701, the local guide program 703, the radio program 705, and the question exercise program 707 are displayed as the related programs. The local guide program 703 provides a guide to cities or countries using the same language as the first program.

When the user of the electronic device 100 performs an operation (reference operation) for shaking the electronic device 100, FIG. 7B illustrates that the electronic device 100 displays in a pop-up window the related programs of the English-Korean dictionary program which is a recently executed program which is stored in the memory 110 through the smart list program 114 on the display unit 131 of the electronic device 100.

The operation for shaking the electronic device 100 as the reference operation describes one embodiment of the present invention. The operation for shaking the electronic device 100 may be changed in a setting step of the smart list program 114.

The pop-up window as a display method of the related programs describes one embodiment of the present invention. The display method may be changed in the setting step of the smart list program 114.

FIG. 8A is a screen view illustrating configuration of a program of an electronic device according to an embodiment of the present invention.

Referring to FIGS. 1 and 8A, the processor 122 sorts programs installed in the memory 110 of the electronic device 100 according to methods such as a folder, the number of times of execution, a category, and a user using the smart list program 114, and verifies the finally sorted day.

A method of successfully performing a process of determining related programs to be used after the first program is executed includes automatically sorting the related programs at a reference date and a reference time to periodically update a use state or change state of each program installed in the memory 110 of the electronic device 100.

As described above, the processor 122 may sort programs installed in the electronic device 100 according to reference conditions through the smart list program 114 and store the sorted programs in the memory 110. Also, the processor 122 may construct and use a database for determining related programs of an executed program.

The processor 122 sorts programs which are installed in the memory 110 of the electronic device 100 and constructs a database. For example, the processor 122 may use program information included in a header of each of the programs installed in the memory 100 of the electronic device 100. The header of each of the programs of the electronic device may include an instruction group used by each of the programs, and identification codes, such as an information program ID, a category ID, a category name, for program configuration, etc.

The processor 122 may acquire necessary information according to reference conditions of the smart list program 114 from the information included in the header of each of the programs installed in the memory 110 of the electronic device 100, sort the programs, construct a database which may manage the sorted programs, and store the constructed database in the memory 110.

For another example, the processor 122 receives information corresponding to each of the programs installed in the memory 110 of the electronic device 100 through an online store, the Internet, a specific server, etc. on an online network using the communication system 136. In general, the programs installed in the memory 110 of the electronic device 100 may be provided and distributed through the online store. The online store or the specific server, etc. may provide information categories of programs, the number of downloads, program evaluation, etc. The processor 122 may directly receive information provided from a manufacturer or a manufacturing company corresponding to each program or verify information through a meta-tag of an online page, the Internet, or the specific server, etc.

The processor 122 may acquire necessary information according to reference conditions of the smart list program 114 through communication with the online store, the Internet, the specific server, etc., sort the programs, construct a database which may manage the sorted programs, and store the constructed database in the memory 110.

For another example, the processor 122 may use a method of analyzing a source code of each of programs installed in the memory 110 of the electronic device 100 and sorting the programs. In general, the programs of the electronic device 100 use a previously appointed instruction such that the processor 122 performs functions of the electronic device 100 according to an instruction included in the source code of each of the programs.

The processor 122 analyzes a source code of each of the programs. For example, in case of an image capturing program #1, a source code of the image capturing program #1 may include an instruction for driving a camera device of the electronic device 100. When a photo or moving picture is captured by the image capturing program #1, the source code of the image capturing program #1 may include an instruction for generating a file with a format corresponding to the photo or moving picture and storing the file in the memory 110.

A source code of an image capturing program #2 may have certain differences with the source code of the image capturing program #1. The source code of the image capturing program #2 may include a previously appointed instruction such that the processor 122 may verify the source code and perform its function. The source code of the image capturing program #2 may include an instruction for configuring the camera device of the electronic device 100 and an instruction for generating a file with a format corresponding to a captured photo and moving picture.

For another example, in case of a first SNS program, a source code of the first SNS program may include an instruction for writing a file of a format corresponding to a photo or moving picture, a text, etc. of the electronic device 100 and transmitting the written file to a specific server on an online network or another electronic device, etc.

A source code of a second SNS program may have certain differences with the source code of the first SNS program. The source code of the second SNS program may include an instruction for writing a file of a format corresponding to a photo or moving picture, a text, etc. of the electronic device 100 and transmitting the written file to a specific server on an online network or another electronic device, etc.

The processor 122 may sort programs, which are installed in the memory 110 of the electronic device 100, whose source code includes the above-described instructions according to a category having the same or similar function.

In addition to the above-described examples, the processor 122 may use various well-known methods when sorting the programs installed in the memory 110 of the electronic device 100 using the smart list program 114.

Although it is not shown in FIG. 8A, in selecting a method of sorting the programs installed in the memory 110 of the electronic device 100, the processor 122 may determine to use at least one method in a setting step of the smart list program 114.

FIG. 8B is a screen view illustrating configuration of a program of an electronic device according to an embodiment of the present invention.

Referring to FIGS. 1, 8A, and 8B, the processor 122 sorts programs installed in the memory 110 of the electronic device 100 using the smart list program 114 in the processes of FIG. 8A. The processor 122 constructs a database for determining related programs using information of the sorted programs. FIG. 8B illustrates an example of category configuration in a database.

For example, the processor 122 may group the sorted programs as the same function category. Also, the processor 122 may group categories having related functions as a related category. Of course, a method of generating a specific category and constructing a database may include instructions included in a source code of the smart list program 114.

The processor 122 configures a category using information of the programs acquired or sorted in the processes of FIG. 8A using the smart list program 114.

It may be verified that an image capturing program #1, an image capturing program #2, and a video capturing program #1 are included in a camera category and an SNS program #1, an SNS program #2, and a messenger program #1 are included in a friendship category. It may be predicted that map, trip, restaurant, education, linguistic dictionary, etc. categories include programs according to a category setting method of the smart list program 114.

Also, the processor 122 may include and configure map, camera, trip, and restaurant categories in a first group and include and configure camera, friendship, and gallery categories in a second group. Accordingly, the processor 122 may configure a group category including categories according to functions.

A description will be given for a method of determining related programs when a first program is executed in the electronic device. For example, when a first sort 809 of FIG. 8C is set to a “category” and an image capturing program #1 is executed as a first program, the processor 122 determines at least one or more programs included in the map, camera, trip, and restaurant categories of the first group including the image capturing program #1 as related programs according to an operation method of the smart list program 114. Also, the processor 122 determines at least one or more programs included in the camera, friendship, and gallery categories of the second group which is another group including the image capturing program #1 as related programs according to an operation method of the smart list program 114.

A description will be given for a method of configuring database information in addition to the category. For example, the processor 122 may group the sorted programs according to the number of times each of the programs is executed, or according to an evaluation score of the sorted programs.

The processor 122 performs an operation of using information about a category, the number of times of download, and an evaluation score of the first program or a second program as a component of the database on an online store which downloads the first program or the second program.

The processor 122 performs an operation of setting information of a category when there is no information of the category or resetting information of a category when there is the information of the category while downloading the first program or the second program on the online store and using the information of the category as a component of the database.

The processor 122 performs an operation of using information of a category provided from a manufacturer of the first program or the second program through a network server or the Internet as a component of the database.

The processor 122 performs an operation of using information verified in a meta tag of an online page for the first program or the second program provided from the manufacturer as a component of the database.

The processor 122 according to one embodiment of the present invention executes a first program, determines related programs to be executed next, and displays the determined related programs to select a second program among the determined related programs. Accordingly, the processor 122 may use information about whether any program is executed after the first program is executed as important information.

The processor 122 acquires information about whether any program is executed as the second program after the first program is executed and information about the number of times of execution using the smart list program 114, configures a list about whether how often any program is executed next per each of programs installed in the memory 110 of the electronic device 100, and stores the configured list in a database.

For another example, the processor 122 may group sorted program according to a folder including the sorted programs. When there is a folder including at least one or more programs installed in the memory 110 of the electronic device 100, if one of the programs included in the folder is executed, setting information of the smart list program 114 is set such that the processor 122 determines the programs included in the folder as related programs.

In order to construct the database for determining the related programs using the smart list program 114, the processor 122 may configure the database according to a method programmed in the smart list program 114 in addition to the above-described methods.

FIG. 8C is a screen view illustrating configuration of a program of an electronic device according to an embodiment of the present invention.

Referring to FIGS. 1, 8B, and 8C, in performing a process of determining related programs of a first program which is being executed using the smart list program 114 and a database stored in the memory 110 and displaying the determined programs on the display unit 131, the processor 122 performs the process according to information input or programmed through a setting step of the smart list program 114.

For example, a “category” is selected and set to only a first sort 809 in a sort item 830 of the smart list program 114 of FIG. 8C, and the image capturing program #1 is executed as a first program. The processor 122 determines at least one or more programs included in the map, camera, trip, and restaurant categories of the first group including the image capturing program #1, as related programs. Also, the processor 122 determines at least one or more programs included in the camera, friendship, and gallery categories of the second group which is another group including the image capturing program #1, as related programs. Also, if “4” is set to the number 801 of programs to be displayed, the processor 122 displays only 4 programs on the display unit 131 in regular sequence on a list of the determined related programs.

For another example, when the “category” is selected and set to the first sort 809 and “the number of times of execution” is selected and set to a second sort 811 in the sort item 830 of the setting step of the smart list program 114 of FIG. 8C and the image capturing program #1 is executed as a first program, the processor 122 determines at least one or more programs included in the map, camera, trip, and restaurant categories of the first group including the image capturing program #1, as related programs. Also, the processor 122 configures at least one or more programs included in the camera, friendship, and gallery categories of the second group which is another group including the image capturing program #1, realigns or filters the programs configured on the list in the order of the number of times of execution according to the “the number of times of execution” of the second sort 811, and determines the realigned or filtered programs as related programs. Herein, if the number 801 of programs to be displayed is set to “4”, the processor 122 displays only 4 programs on the display unit 131 in regular sequence on the list of the determined related programs.

The processor 122 performs a control operation to configure a GUI operation according to setting information of the smart list program 114 and displays the determined related programs on the display unit 131.

For example, when the processor 122 configures a GUI operation according to setting information of FIG. 8C, as shown in FIG. 6, the GUI operation displayed on the display unit 131 may be displayed.

Referring to FIGS. 6 and 8C, when the number 801 of programs to be displayed is set to 4 in an item 820 for setting an interface, the processor 122 displays the image capturing program #601, the bus route map program 603, the subway route map program 605, and the restaurant search program 607 on the display unit 131.

In addition, when a display method 803 is set to display on a notification bar, the processor 122 displays recommended related programs 620 and a recently executed related program 610 on the notification bar of the display unit 131.

Herein, because the display method 803 is set to the display on the notification bar, a display type is not used. However, when the display method 803 is selected and set to a left upper end, a right upper end, a central upper end, a left lower end, a right lower end, a central lower end, etc., the display type 805 may be selected and set to be long left and right, long up and down, square, etc.

In addition, transparency 807 is selected and set to transparency of icons of the related programs 601, 603, 605, and 607 displayed on the display unit 131.

When operation sensing 815 is set to “shaking” in an item 840 for setting a selection function, as shown in FIG. 7B, if a first program has ended, the processor 122 displays related programs of the first program on the display unit 131 by an operation (reference operation) for shaking the electronic device 100. As shown in FIG. 6, when an operation for shaking the electronic device 100 is performed in a state where a map program has ended, the processor 122 displays related programs of the map program on the display unit 131.

In addition, when recently execution display 817 is set to “yes”, when executing a map program (first program) which is recently executed together with related programs 620 of FIG. 6, the processor 122 displays the bus route map program 603 selected among related programs displayed on the display unit 131 on a dotted box 610.

As described above, the processor according to an embodiment of the present invention may select one of related programs displayed on the first program anytime while the first program is executed, and execute the selected program as the second program to be used next without the process of ending the first program, and searching and executing the desired second program on the program list by configuring and displaying programs to be used after the first program is executed.

In accordance with another embodiment of the present invention, when the first program has ended while any one of related programs displayed on the display unit is not executed after the first program is executed, it will be still necessary to execute any one program related with the first program. Herein, the processor may select a second program to be used next without searching a program list installed in the electronic device by performing a simple reference operation of the electronic device before another program is executed after the first program has ended, and displaying the related programs of the first program on the display unit.

Methods according to claims of the present invention and/or embodiments described in the specification of the present invention may be implemented as hardware, software, or a combination of the hardware and the software.

When the method is implemented by software, a computer-readable storage medium for storing one or more programs (software modules) may be provided. The one or more programs stored in the computer-readable storage medium may be executed by one or more processors in the electronic device 100. The one or more programs include instructions for allowing the electronic device 100 to execute the methods according to the claims of the present invention and/or the embodiments described in the specification of the present invention.

These programs (software module, software) may be stored in a Random Access Memory (RAM), a non-volatile memory including a flash memory, a Read Only Memory (ROM), an Electrically Erasable Programmable ROM (EEPROM), a magnetic disc storage device, a Compact Disc-ROM (CD-ROM), a Digital Versatile Disc (DVD) or an optical storage device of a different type, and a magnetic cassette. The programs may also be stored in a memory configured by combination of some or all of them. Also, the configured memory may include a plurality of memories.

The programs may also be stored in an attachable storage device which may access the electronic device 100 through communication networks such as the Internet, an intranet, a Local Area Network (LAN), a Wide LAN (WLAN), and a Storage Area Network (SAN) or a communication network configured by combination of them. This storage device may connect to the electronic device 100 through an external port.

Also, a separate storage device on a communication network may connect to the portable electronic device 100.

While the present invention has been particularly shown and described with reference to certain embodiments thereof, it will be understood by those skilled in the art that various changes in form and details may be made therein without departing from the spirit and scope of the present invention as defined by the appended claims.

What is claimed is:

1. An operation method in an electronic device, the operation method comprising:
executing a first program;
determining at least two related programs related to the first program; and
displaying at least the two related programs on a reference region, a notification bar, or a pop-up window of a display unit on which the first program is executed,
wherein the relation between the first program and the at least two related programs is verified using a database stored in the electronic device.

2. The operation method of claim 1, wherein the database is made by configuring the relation between the first program and a second program by using at least one of using information about a category, the number of times of download, and an evaluation score of the first program or the second program as a component of the database on an online store which downloads the first program or the second program, setting information of a category when there is no information of the category or resetting information of a category when there is the information of the category while downloading the first program or the second program on the online store and using the information of the category as a component of the database, using information of a category provided from a manufacturer of the first program or the second program through a network server or the Internet as a component of the database, and using information verified in a meta tag of an online page for the first program or the second program provided from the manufacturer as a component of the database.

3. The operation method of claim 1, wherein determining the at least two related programs comprises:
verifying a program ID from a header of the first program; and
determining the related programs in the database using the program ID.

4. The operation method of claim 1, wherein the database is made by configuring the relation between the first program and the second program to have the relation with each other when a source code of the first program or the second program includes a keyword or an instruction of the number of reference types or more, which is processed to perform the same function of the electronic device.

5. The operation method of claim 1, wherein displaying the at least two related programs comprises executed sensing a reference operation before the second program is executed after the first program is executed.

6. The operation method of claim 1, wherein the database is made by acquiring the number of times a second program is executed after the first program is executed and configuring the relation between the first program and the second program to have the relation with each other when the number of times the second program is executed is included in a reference number of times.

7. The operation method of claim 1, wherein the database is made by configuring the relation between the first program and the second program such that a second program which is another component of a first folder is related to the first program when the first program is one component of the first folder.

8. The operation method of claim 7, wherein the database is made by configuring the relation between the first program and the second program such that the second program and a third program which is another component of a second folder is related to the first program when the first program is one component of each of the first folder and the second folder.

9. An operation method of an electronic device, the operation method comprising:
executing a camera program;
determining a map program, a gallery program, an SNS program, and a photo and video editing program as programs related to the camera program according to reference conditions; and
displaying the related programs on a reference region, a notification bar, or a pop-up window of a display unit on which the camera program is displayed,
wherein the related programs are determined by position relation between the camera program which stores position information and the map program which verifies a position of the electronic device in comparison with a database stored in the electronic device, format relation between a result format of the camera program and the gallery program which uses data of the result format, format or result relation between a result of the camera program and the SNS program which shares the result on online, and the format relation between the result format of the camera program and the editing program which uses the data of the result format.

10. An operation method of an electronic device, the operation method comprising:
sensing a reference operation, while a linguistic program is executed or before a second program is executed after the linguistic program is executed; and
displaying related programs which are determined after the linguistic program is executed and are related to the linguistic program on a reference region, a notification bar, or a pop-up window of a display unit on which the linguistic program is displayed, when the reference operation is sensed,
wherein the related programs include two or more of a dictionary program including the same language as the linguistic program using identification information of programs which are sorted in a database by a category, an online linguistic education program including the same language as the linguistic program, a local guide program for guiding countries or cities which use the same language as the linguistic program, and other linguistic programs.

11. An electronic device comprising:
at least one processor;
a memory; and
at least one program, which is stored in the memory and is executed by the at least one processor,
wherein the program includes an instruction for determining at least two related programs related to a first program and displaying the at least two related programs on a reference region, a notification bar, or a pop-up window of a display unit on which the first program is executed and wherein the relation between the first program and the at least two related programs is verified in a database stored in the electronic device.

12. The electronic device of claim 11, wherein the program includes an instruction for using information about a category, the number of times of download, and an evaluation score of the first program or a second program as a component of the database on an online store which downloads the first program or the second program, setting information of a category when there is no information of the category or resetting information of a category when there is the information of the category while downloading the first program or the second program on the online store and using the information of the category as a component of the database, using information of a category provided from a manufacturer of the first program or the second program through a network server or the Internet as a component of the database, and using information verified in a meta tag of an online page for the first program or the second program provided from the manufacturer as a component of the database.

13. The electronic device of claim 11, wherein the program includes an instruction for verifying a program ID from a header of the first program and determining the related programs in the database using the program ID.

14. The electronic device of claim 11, wherein the program includes an instruction for configuring the relation between the first program and the second program to have the relation with each other when a source code of the first program or the second program includes a keyword or an instruction of the number of reference types or more, which is processed to perform the same function of the electronic device.

15. The electronic device of claim 11, wherein the program includes an instruction for displaying the at least two related programs when a reference operation is sensed before the second program is executed after the first program is executed.

16. The electronic device of claim 11, wherein the program includes an instruction for acquiring the number of times a second program is executed after the first program is executed and configuring the relation between the first program and the second program to have the relation with each other when the number of times the second program is executed is included in the reference number of times.

17. The electronic device of claim 11, wherein the program includes an instruction for configuring the relation between a second program which is another component of a first folder and the first program when the first program is one component of the first folder.

18. The electronic device of claim 17, wherein the program includes an instruction for configuring the relation between the second program and a third program which is another component of a second folder and the first program when the first program is one component of each of the first folder and the second folder.
